(19) United States
(12) Patent Application Publication
(10) Pub. No.: US 2017/0104219 A1
(43) Pub. Date: Apr. 13, 2017

(54) METHOD FOR PRODUCING CORE-SHELL CATALYST FOR FUEL CELLS

(71) Applicants: Toyota Jidosha Kabushiki Kaisha, Toyota-shi Aichi-ken (JP); Brookhaven Science Associates, LLC, Upton, NY (US)

(72) Inventors: Makoto Adachi, Numazu-shi Shizuoka-ken (JP); Yasuyuki Ohki, Susono-shi Shizuoka-ken (JP); Tetsuya Ogawa, Mishima-shi Shizuoka-ken (JP); Radoslav Adzic, East Setauket, NY (US); Jia Xu Wang, East Setauket, NY (US); Yu Zhang, Center Moriches, NY (US)

(21) Appl. No.: 14/878,522

(22) Filed: Oct. 8, 2015

(51) Int. Cl. H01M 4/86; H01M 4/92

(52) U.S. Cl. CPC H01M 4/8657; H01M 4/926

(57) ABSTRACT

The present invention is to provide a method for producing a core-shell catalyst for fuel cells, which is configured to facilitate shell deposition by, in the production of the core-shell catalyst for fuel cells, decreasing an oxidation-reduction potential applied for shell deposition lower than ever before. Disclosed is a method for producing a core-shell catalyst for fuel cells, wherein the method comprises: a first refluxing step of refluxing a mixture A containing a core fine particle-supported carbon, alcohol and water; a mixing step of preparing a mixture B by, after the first refluxing step, mixing the mixture A having a temperature that is lower than that in the first refluxing step with a shell material; and a second refluxing step of refluxing the mixture B.

This invention was made under CRADA No. BNL-C-11-05 between Toyota Motor Corporation and Brookhaven National Laboratory operated for the United States Department of Energy. This invention was made with Government support under contract number DE-AC02-98CH10886 and DE-SC0012704, awarded by the U.S. Department of Energy.

The Government has certain rights in this invention.

### TECHNICAL FIELD

The present invention relates to a method for producing a core-shell catalyst for fuel cells, which is configured to facilitate shell deposition by, at the time of shell deposition, decreasing an oxidation-reduction potential lower than ever before.

### BACKGROUND ART

As a catalyst cost reducing technique, a technique relating to a core-shell catalyst is known, which has a structure including a core fine particle and a shell covering the core fine particle (i.e., the core-shell structure). By using a relatively inexpensive material for the core fine particles of the core-shell catalyst, the cost of the inside of the core-shell catalyst, which rarely involves in catalyst reaction, can be kept low. In Patent Literature 1, a method for producing a core-shell catalyst for fuel cells is disclosed, which is a method for electrochemically covering palladium-containing particles supported on a carbon support with a platinum-containing layer, which is the outermost layer, after the carbon support is made finer.

Since the prior art disclosed in Patent Literature 1 includes complicated processes, it is needed to simplify the production processes and decrease the production costs. Meanwhile, a method for covering palladium surface with platinum is disclosed in Non-patent Literature 1, in which a suspension composed of a palladium-supported carbon suspended in alcohol is refluxed, thereby allowing the alcohol to function as a reducing agent and covering the palladium surface with platinum.

### CITATION LIST

Patent Literature 1: Japanese Patent Application Laid-Open No. 2013-239331
Non-patent Literature 1: Zhang, Yu et al., ACS Catalysis, 2014, 4, 738-742

### SUMMARY OF INVENTION

### Technical Problem

However, a sufficient amount of platinum is not always deposited even by the method disclosed in Non-patent Literature 1. The reason is presumed as follows.

In general, the reducing ability of alcohol is increased by temperature. Using this phenomenon, a technique to deposit a platinum shell on a palladium surface by refluxing ethanol, is disclosed in Non-patent Literature 1.

However, in the method disclosed in Non-patent Literature 1, pure ethanol is used, so that the pure ethanol cannot be heated to or more than the boiling point thereof, and the temperature of the reaction mixture remains about 78° C. Accordingly, it is difficult to further increase the reducing ability of the alcohol by heating. As a result, the deposition yield of the platinum added is not expected to increase, and defects may occur in the thus-obtained platinum shell. In the method disclosed in Non-patent Literature 1, it may be possible to increase the boiling point by applying pressure upon heating and to increase the temperature of the reaction mixture. In this method, however, production facilities with pressure resistance are needed and result in high costs.

The present invention was achieved in light of the above circumstances in shell deposition. An object of the present invention is to provide a method for producing a core-shell catalyst for fuel cells, which is configured to facilitate shell deposition by, at the time of shell deposition, decreasing an oxidation-reduction potential lower than ever before.

### Solution to Problem

The method for producing a core-shell catalyst for fuel cells according to the present invention comprises: a first refluxing step of refluxing a mixture A containing a core fine particle-supported carbon, alcohol and water; a mixing step of preparing a mixture B by, after the first refluxing step, mixing the mixture A having a temperature that is lower than that in the first refluxing step with a shell material; and a second refluxing step of refluxing the mixture B.

### Advantageous Effects of Invention

According to the present invention, by containing water in the mixture B, the boiling point of the dispersion medium in the mixture B can be increased and, in the second refluxing step, the oxidation-reduction potential in the mixture B can be decreased. As a result, a shell can be deposited more and uniformly on the surface of the core fine particles.

### BRIEF DESCRIPTION OF DRAWINGS

FIG. 1 is a view in which a graph showing the transition of oxidation-reduction potential (ORP) in Example 1 and that in Comparative Example 1 are overlapped on each other.

FIG. 2 is a bar graph comparing the catalyst mass activity (A/g-Pt) of the core-shell catalyst for fuel cells of Example 1 to that of Comparative Example 1.

### DESCRIPTION OF EMBODIMENTS

The method for producing a core-shell catalyst for fuel cells according to the present invention comprises: a first refluxing step of refluxing a mixture A containing a core fine particle-supported carbon, alcohol and water; a mixing step of preparing a mixture B by, after the first refluxing step, mixing the mixture A having a temperature that is lower than that in the first refluxing step with a shell material; and a second refluxing step of refluxing the mixture B.

The present invention includes (a) the first refluxing step, (b) the mixing step, and (c) the second refluxing step. The present invention is not limited to these three steps only. In addition to the three steps, the present invention can include the below-described filtering step, washing step and drying step, for example.

Hereinafter, the steps (a) to (c) and other steps will be described in order.

### 1. First Refluxing Step

This is a step of refluxing a mixture A containing a core fine particle-supported carbon, alcohol and water.

As the core material used for the core fine particles, palladium, gold, silver and alloys thereof can be used. Of them, palladium or palladium alloy is preferred as the core material, and palladium is more preferred.

The method for producing the core fine particle-supported carbon is not particularly limited. The carbon can be produced by known methods such as prior arts. For example, as the method for producing palladium-supported carbon, the method disclosed in Patent Literature 1 can be used. The type of the carbon, which serves as a support, can be determined by reference to prior arts.

In this step, a mixed solution of alcohol and water (hereinafter may be referred to as alcohol-water mixed solution) is used as a dispersion medium.

In the alcohol reduction method, to deposit a shell on the surface of core fine particles, alcohol (dispersion medium) is used as a reducing agent. However, pure ethanol has been used as the reducing agent (see Non-patent Literature 1). Therefore, even when the reaction mixture is refluxed, the temperature can rise only up to 78° C., which is the boiling point of ethanol. Therefore, even at the time of refluxing, the oxidation-reduction potential of the reaction mixture remains high, and the reaction mixture cannot be sufficiently reduced.

Accordingly, by using the alcohol-water mixed solution as the dispersion medium, refluxing can be carried out at higher temperature than ever before. As a result, the oxidation-reduction potential of the reaction mixture can be kept low, and the reaction mixture can be sufficiently reduced.

Ethanol is preferred as the alcohol of the alcohol-water mixed solution, because it has sufficiently high reducing ability at the time of refluxing.

In the alcohol-water mixed solution, the content ratio of the alcohol to the water is not particularly limited. The content ratio is preferably alcohol:water=5:95 to 80:20 (% by volume), more preferably alcohol:water=10:90 to 50:50 (% by volume). When the water content ratio is too high, the alcohol (reducing agent) content ratio is relatively small. Accordingly, the reaction mixture may not be sufficiently reduced. On the other hand, when the alcohol content ratio is too high, the boiling point of the alcohol-water mixed solution is not sufficiently increased and, as a result, the reaction mixture may not be sufficiently reduced even by refluxing.

At the time of refluxing, the boiling point of the alcohol-water mixed solution serves as the upper limit of the temperature of the reaction mixture. Therefore, the temperature of the reaction mixture depends on the content ratio of the alcohol to the water, and the type of the alcohol. The boiling point of the alcohol-water mixed solution is preferably a temperature that is more than 78° C. and less than 100° C., more preferably a temperature that is 80° C. or more and 90° C. or less.

At the time of refluxing, the heating temperature varies depending on a heating device. For example, in the case of using an oil bath or the like, the temperature can be 80° C. or more and 150° C. or less.

### 2. Mixing Step

This is a step of preparing a mixture B by, after the first refluxing step, mixing the mixture A having a temperature that is lower than that in the first refluxing step with a shell material.

The mixture A used in this step is the reaction mixture which has been subjected to the first refluxing step and which has a temperature that is lower than that in the first refluxing step. The mixture A having a temperature that is lower than that in the first refluxing step encompasses the mixture A which was cooled after the first refluxing step, and the mixture A which was allowed to stand after the first refluxing step and, as a result, was naturally cooled.

The reason for the use of such a low-temperature mixture A is as follows. That is, a shell can be more thinly and uniformly deposited on the core fine particle surface by adding the shell material to the low-temperature mixture A and gradually increasing the temperature in the below-described second refluxing step, rather than by adding the shell material to the high-temperature mixture A.

The shell material used in this step is not particularly limited, as long as it is a material that can deposit the shell on the core fine particle surface by being mixed with the mixture A and by the below-described second refluxing step.

A platinum or platinum alloy shell can be considered as the shell to be deposited on the core fine particle surface. Therefore, as the shell material, there may be mentioned platinum, platinum alloys, platinum compounds and mixtures thereof, for example. As a concrete example of the shell material, there may be mentioned hexachloroplatinic (IV) acid (H₂Pt(IV)Cl₆). The shell material can be mixed as it is with the mixture A, or it can be appropriately dissolved in alcohol or the like and mixed with the mixture A in the form of an alcohol solution.

### 3. Second Refluxing Step

This is a step of refluxing the mixture B obtained by the mixing step. In this step, the shell is deposited on the core fine particle surface.

At the time of refluxing, the heating temperature is the same as the first refluxing step. As described above, the boiling point of the dispersion medium is higher compared to the conventional alcohol reduction method. Therefore, at the time of refluxing, the temperature of the mixture B can be higher than ever before. As a result, the oxidation-reduction potential of the mixture B can be kept low, so that the shell material can be deposited more on the core fine particle surface.

At the time of refluxing, it is preferable to add an alkaline compound to the mixture B. The alkaline compound that can be used here is the same as the first refluxing step.

### 4. Other Steps

After the deposition of the shell, filtering of the thus-obtained reaction mixture, washing of the thus-obtained core-shell catalyst, drying of the same, etc., can be carried out.

The filtering and washing are not particularly limited, as long as they are carried out by methods that can remove impurities without any damage to the core-shell structure of the thus-obtained core-shell catalyst. The drying of the core-shell catalyst is not particularly limited, as long as it is carried out by a method that can remove solvents, etc.

The core-shell catalyst produced by the present invention can be used as a catalyst for fuel cells.

### EXAMPLE

Hereinafter, the present invention will be described in more detail, by way of an example and a comparative example. However, the scope of the present invention is not limited to these examples.

### 1. Production of Core-Shell Catalyst for Fuel Cells

### Example 1

First, 1 g of 30% by mass palladium-supported carbon powder (Pd/C) and 0.5 L of 15% aqueous ethanol solution (dispersion medium) were put in a beaker. The mixture in the beaker was stirred with a homogenizer to disperse the Pd/C in the ethanol, thereby preparing a Pd/C dispersion.

Next, a thermometer, a condenser and a three-way cock were connected with the three necks of a three-necked flask.

Then, the Pd/C dispersion in the beaker was transferred to the three-necked flask. A temperature-controlled oil bath was installed on a magnetic stirrer, and the body of the three-necked flask was immersed in the oil bath.

Next, with stirring the Pd/C dispersion in the three-necked flask, the dispersion was heated to bring the dispersion medium to boil and refluxed for one hour (the first refluxing step).

Meanwhile, 0.214 g of H₂Pt(IV)Cl₆ (platinum equivalent) was taken and dissolved in 21.8 mL of 100% ethanol, thereby preparing a 0.05M H₂Pt(IV)Cl₆ ethanol solution.

After the one hour of refluxing, the mixture was cooled until the temperature reached a range of 15 to 30° C. The 0.05M H₂Pt(IV)Cl₆ ethanol solution was added to the cooled mixture (the mixing step).

With stirring the resulting mixture, the temperature of the oil bath was increased to 110° C. to bring the mixture to boil, and the mixture was refluxed for two hours (the second refluxing step). At this time, the temperature of the dispersion medium was 85° C. After the two hours of refluxing, 21.8 mL of a 0.1 M KOH aqueous solution was added to the mixture, and the heating was stopped.

After the heating, the mixture was cooled until the temperature reached a range of 15 to 30° C. Then, the mixture was filtered, and a solid thus obtained was washed with ethanol and water. Then, the solid was dried overnight under reduced pressure, at a temperature condition of 60° C.

The solid thus obtained was used as the core-shell catalyst for fuel cells of Example 1.

### Comparative Example 1

First, 1 g of 30% by mass palladium-supported carbon powder (Pd/C) and 0.5 L of 100% ethanol (dispersion medium) were put in a beaker. The mixture in the beaker was stirred with a homogenizer to disperse the Pd/C in the ethanol, thereby preparing a Pd/C dispersion.

Then, in the same manner as Example 1, the connecting of the instruments with the three-necked flask, the transferring of the Pd/C dispersion to the three-necked flask, the installing of the temperature-controlled oil bath and the magnetic stirrer, the first refluxing step, the preparing of the 0.05M H₂Pt(IV)Cl₆ ethanol solution, and the mixing step were carried out.

With stirring the mixture obtained by the mixing step, the temperature of the oil bath was increased to 80° C. to bring the mixture to boil, and the mixture was refluxed for two hours (the second refluxing step). At this time, the temperature of the dispersion medium was 78° C. After the two hours of refluxing, 21.8 mL of 0.1 M KOH aqueous solution was added to the mixture, and the heating was stopped.

Then, cooling, filtering, washing and drying under reduced pressure were carried out in the same manner as Example 1, thereby obtaining a solid. The solid thus obtained was used as the core-shell catalyst for fuel cells of Comparative Example 1.

### 2. Measurement of Oxidation-Reduction Potential (ORP)

In Example 1 and Comparative Example 1, using an ORP meter, the oxidation-reduction potential (ORP) of the mixture in the three-necked flask was measured at the following seven points:

(0) Just before starting the first refluxing step

(1) Just after finishing the first refluxing step

(2) Just after cooling the mixture after the first refluxing step

(3) Just after starting the mixing step

(4) Just after finishing the second refluxing step

(5) Just after adding the KOH aqueous solution

(6) Just after cooling the mixture after the second refluxing step

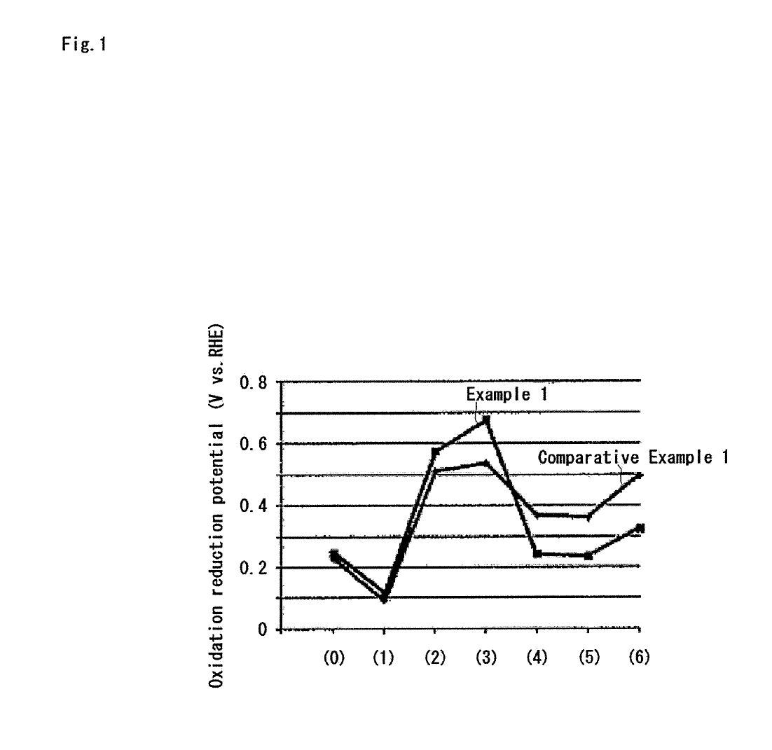

FIG. 1 is a view in which a graph showing the transition of oxidation-reduction potential (ORP) in Example 1 and that in Comparative Example 1 are overlapped on each other. The following Table 1 shows the oxidation-reduction potential values (V vs. RHE) of the mixtures at the points (0) to (6).

TABLE 1

| | (0) | (1) | (2) | (3) | (4) | (5) | (6) |
|---|---|---|---|---|---|---|---|
| Example 1 | 0.25 | 0.10 | 0.58 | 0.68 | 0.24 | 0.23 | 0.32 |
| Comparative | 0.25 | 0.12 | 0.50 | 0.53 | 0.38 | 0.37 | 0.50 |
| Example 1 | | | | | | | |

### 3. Calculation of Platinum Yield

A part of the core-shell catalyst for fuel cells of Example 1 and that of Comparative Example 1 were analyzed with Inductively Coupled Plasma (ICP), and the mass composition of carbon and each metal of each catalyst was obtained. Next, the platinum yield (g) of the catalyst was estimated from the mass (1 g) of the Pd/C (material) and the mass composition thus obtained. The platinum yield (g) was divided by the used platinum amount (0.214 g), and the resultant was multiplied by 100. The value thus obtained was used as the platinum yield (%) of the catalyst.

### 4. Measurement of Catalyst Mass Activity

The catalyst mass activity of the core-shell catalyst of Example 1 and that of Comparative Example 1 were measured by the rotating disk electrode (RDE) method.

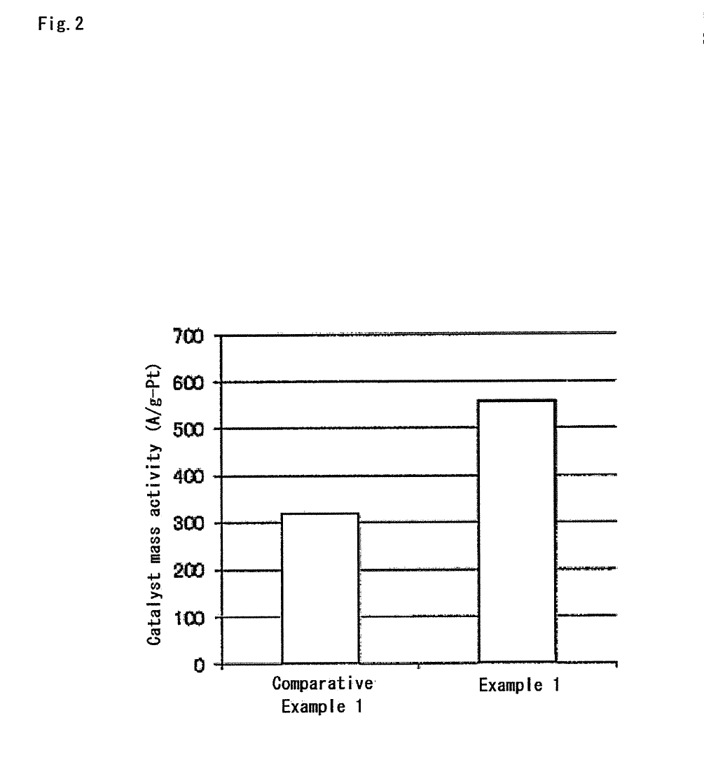

FIG. 2 is a bar graph comparing the catalyst mass activity (A/g-Pt) of the core-shell catalyst for fuel cells of Example 1 to that of Comparative Example 1. The catalyst mass activity shown in FIG. 2 corresponds to the specific activity of each catalyst in 0.1 M perchloric acid aqueous solution with respect to the oxygen reduction activity (ORR) of the same.

The following Table 2 shows the used platinum amount (g), platinum yield (g), platinum yield (%) and catalyst mass activity (mAh/g-Pt) of Example 1 and those of Comparative Example 1.

TABLE 2

| | Used platinum | Platinum | Platinum | Catalyst mass |
|---|---|---|---|---|
| | amount | yield | yield | activity |
| | (g) | (g) | (%) | (A/g-Pt) |
| Example 1 | 0.214 | 0.209 | 97.9 | 560 |
| Comparative | 0.214 | 0.195 | 91.4 | 320 |
| Example 1 | | | | |

### 5. Consideration

First, as is clear from FIG. 1 and Table 1, until just after finishing the first refluxing step ((1) in FIG. 1), there is no substantial difference between the oxidation-reduction potential of Example 1 and that of Comparative Example 1. However, after the subsequent cooling and just after adding the 0.05M H₂Pt(IV)Cl₆ ethanol solution, the oxidation-reduction potential of Example 1 was 0.15 V higher than that of Comparative Example 1 ((3) in FIG. 1). The reason is thought to be that the deposited platinum was partly oxidized.

On the other hand, just after finishing the second refluxing step, the oxidation-reduction potential of Example 1 was 0.14 V lower than that of Comparative Example 1 ((4) in FIG. 1). The reason is thought to be as follows: by using the aqueous ethanol solution as the dispersion medium, the boiling point was increased higher than the case of using the 100% ethanol as the dispersion medium, so that the oxidation-reduction potential was decreased.

Next, as is clear from FIG. 2 and Table 2, while the catalyst mass activity of Comparative Example 1 is 320 A/g-Pt, the catalyst mass activity of Example 1 is 560 A/g-Pt. As just described, the core-shell catalyst for fuel cells of Example 1 has the catalyst mass activity that is 1.8 times higher than the core-shell catalyst for fuel cells of Comparative Example 1.

Also, while the platinum yield of Comparative Example 1 is 91.4%, the platinum yield of Example 1 is 97.9%. The platinum amount used in the synthesis of the catalyst was the minimum amount which is required to cover the whole palladium fine particle surface. Therefore, it is clear that in the core-shell catalyst for fuel cells of Example 1, almost all of the palladium fine particle surface is covered with platinum. The reason for such an increase in platinum yield is as follows. In conventional methods in which, like Comparative Example 1, 100% ethanol is used as the dispersion medium, the reducing ability of the ethanol is not sufficiently high at the time of platinum deposition, so that the amount of deposited platinum is small. In contrast, like Example 1, by using the aqueous ethanol solution as the dispersion medium, the temperature can be increased higher than conventional methods at the time of refluxing, and the reducing ability of the ethanol is thus increased. As a result, almost all of the platinum can be deposited, and the platinum yield can be increased.

That is, the reason for the increase in platinum yield can be summarized as follows. First, due to the use of the aqueous ethanol solution, the reducing ability of the ethanol was increased higher than conventional methods in which 100% ethanol is used. As a result, the palladium surface area on which the platinum can be deposited was increased, and the palladium surface was more reduced; therefore, more platinum was deposited. Also, due to the increase in the reducing ability of the ethanol, the platinum deposition itself was promoted.

Because of the above reasons, in Example 1 in which the aqueous ethanol solution was used, the oxidation-reduction potential can be kept lower than Comparative Example 1 in which 100% ethanol was used, at the time of shell deposition. As a result, it has been proved that the core-shell catalyst which is excellent in platinum yield and catalyst mass activity was obtained.

What is claimed is:

1. A method for producing a core-shell catalyst for fuel cells, wherein the method comprises:
a first refluxing step of refluxing a mixture A containing a core fine particle-supported carbon, alcohol and water;
a mixing step of preparing a mixture B by, after the first refluxing step, mixing the mixture A having a temperature that is lower than that in the first refluxing step with a shell material; and
a second refluxing step of refluxing the mixture B.
